(19) United States
(12) Patent Application Publication
(10) Pub. No.: US 2023/0214666 A1
(43) Pub. Date: Jul. 6, 2023

(54) MACHINE LEARNING SYSTEM, CLIENT, MACHINE LEARNING METHOD AND PROGRAM

(71) Applicant: NEC Corporation, Minato-ku, Tokyo (JP)

(72) Inventor: Hikaru TSUCHIDA, Tokyo (JP)

(73) Assignee: NEC Corporation, Minato-ku, Tokyo (JP)

(21) Appl. No.: 18/008,492

(22) PCT Filed: Jun. 9, 2020
(86) PCT No.: PCT/JP2020/022633

§ 371 Date: Dec. 6, 2022

(51) Int. Cl. G06N 3/098

(52) U.S. Cl. CPC G06N 3/098

(57) ABSTRACT

A client is provided with a property classification model training part that trains a classification model, the classification model inferring a property of an input data from the gradient information and a target model training part that computes the gradient information of the target model using a training data, the target model and the classification model and transmits the gradient information to the server. The property of the input data that the classification model infers can be set for each client, and the property classification model training part trains the classification model using the target model and a second training data labelled with a teacher label regarding the property of the input data.

This application is a National Stage Entry of PCT/JP2020/022633 filed on Jun. 9, 2020, the contents of all of which are incorporated herein by reference, in their entirety.

### FIELD

The present invention relates to a machine learning system, a client, a machine learning method and a program.

### BACKGROUND

In recent years, a form of machine learning called Federated Learning (hereinafter referred to as “federated learning” or “collaborative learning”), in which a client performs a machine learning and a server receives model update parameter from the client and updates a neural network model, has attracted attention. Since the federated learning does not require to collect training data on a single node, it is possible to protect privacy and reduce the amount of data communication. Here, the model update parameter is a parameter for updating a neural network model (hereinafter referred to as “target model”) and is called hereinafter as a gradient information.

Patent Literature 1 discloses a configuration for performing a machine learning of the above-mentioned federated learning type. Here, “update amount” in the Patent Literature 1 corresponds to the above-mentioned model update parameter (gradient information). Patent Literature 2 discloses a universal learned model generation method capable for generating a universal learned model, in which a group of operating devices having the same configuration can be controlled properly.

In Non-Patent Literature 1, it is pointed out that in the federated learning described above, when a learning model (target model) is back to each client, a malicious client can attack an other client(s) by computing a difference and using a gradient, resulting in unintended privacy violation. In the Non-Patent Literature 1, sharing fewer gradients, reducing the dimensionality (Dimensionality reduction), Dropout, and DP-noise (Participant-level differential privacy) are proposed as possible defenses against the above attack (see “8 Defenses” in the Non-Patent Literature 1).

In addition, an Adversarial Regularization disclosed in a Non-Patent Literature 2 is attracted attention, as a promising defense against an MI (Membership Inference) attack on a learning model (target model). Concretely, an algorithm used in the Non-Patent Literature 2 uses a binary classifier that performs a virtual MI attack during training to add its gain as a regularization term (regularizer). In Non-patent Literature 2, the method is employed that improves the resistance against the MI attack by iterating a min-max process of (1) minimizing a loss function and a gain of the binary classifier and (2) maximizing a gain of the binary classifier.
Patent Literature 1: Japanese Patent Laid-Open No. 2019-28656
Patent Literature 2: International Publication No. 2019/131527
Non-Patent Literature 1: Melis, Luca, et al., “Exploiting unintended feature leakage in collaborative learning”, 2019 IEEE Symposium on Security and Privacy (SP),2019., [online], [searched on May 12, 2020], Internet <URL:https://arxiv.org/pdf/1805.04049.pdf>
Non-Patent Literature 2: Milad Nasr, Reza Shokri, Amir Houmansadr,“Machine Learning with Membership Privacy using Adversarial Regularization”, [online], [searched on May 12, 2020], Internet <URL:https://arxiv.org/pdf/1807.05852.pdf>

### SUMMARY

The following analysis is given by the present inventor. Since one of the advantages of the federated learning is the protection of privacy, there is a demand to make it difficult to derive (or infer) an arbitrary attribute of data used for learning from the target model. In this respect, the defense method proposed in Non-Patent Literature 1 does not provide a defense according to a property of a data used for learning for each client.

Also, the method disclosed in Non-Patent Literature 2 specializes in making it difficult to infer whether or not a certain data is a data used for training (Member data), and cannot be a defense according to a property of a data used for learning for each client.

It is an object of the present invention to provide a machine learning system, a client, a machine learning method and a program that can contribute to make it difficult for each client participating in the federated learning to infer arbitrary properties (attributes) of data used for learning their respective target models.

According to a first aspect, there is provided a client capable of performing a federated learning on a target model with a server together with other clients. The clients is provided with a property classification model training part that trains a classification model, the classification model inferring a property of an input data from a gradient information, and a target model training part that computes the gradient information of the target model using a training data, the target model and the classification model and transmits the gradient information to the server. The property of the input data that the classification model infers can be set for each client, and the property classification model training part trains the classification model using the target model and a second training data labelled with a teacher label regarding the property of the input data.

According to a second aspect, there is provided a machine learning system including a server comprising a federated learning part that trains a target model by exchanging a model update parameter including a gradient information with a client by a federated learning and above-mentioned client apparatus.

According to a third aspect, there is provided a machine learning method wherein a client, connectable to a server, the server having a federated learning part, the federated learning part exchanging model update parameter including a gradient information with the client by a federated learning to train a target model, trains a classification model, the classification model inferring a property of an input data from the gradient information and computes the gradient information of the target model using a training data, the target model and the classification model, and transmitting the gradient information to the server. The property of the input data that the classification model infers can be set for each client, and the property classification model training part trains the classification model using the target model and a second training data labelled with a teacher label regarding the property of the input data.

According to a fourth aspect, there is provided a computer program for realizing the functions of the above computer. This program can be inputted to a computer apparatus via an input device or a communication interface from the outside, be stored in a storage device, cause a processor to drive in accordance with predetermined steps or processing, and display, as needed, a processing result including an intermediate state per stage on a display device or communicate with the outside via the communication interface. For example, the computer apparatus for this purpose typically includes a processor, a storage device, an input device, a communication interface, and a display device as needed, which can be connected to each other via a bus. In addition, this program can be a recorded in a computer-readable (non-transitory) storage medium.

The present invention can contribute to make it difficult for each client participating in a federated learning to infer arbitrary properties (attributes) of data used for learning their respective target models.

### BRIEF DESCRIPTION OF DRAWINGS

FIG. 1 is a block diagram illustrating a configuration according to an example embodiment of the present invention.

FIG. 2 is a block diagram illustrating a configuration according to a first example embodiment of the present invention.

FIG. 3 is a diagram for describing a whole operation according to the first example embodiment of the present invention.

FIG. 4 is a diagram for describing a procedure to compute a gradient information at a client according to the first example embodiment of the present invention.

FIG. 5 is a block diagram illustrating a configuration according to a second example embodiment of the present invention.

FIG. 6 is a block diagram illustrating a configuration according to a third example embodiment of the present invention.

FIG. 7 is a diagram illustrating a configuration of a computer that constitutes a machine learning apparatus according to the present invention.

### EXAMPLE EMBODIMENTS

First, an outline of an example embodiment of the present invention will be described with reference to drawings. In the following outline, various components are denoted by reference characters for the sake of convenience. That is, the following reference characters are merely used as examples to facilitate understanding of the present invention. Thus, the description of the outline is not meant to limit the present invention to the illustrated modes. An individual connection line between blocks in the drawings, etc. referred to in the following description signifies both one-way and two-way directions. An arrow schematically illustrates a principal signal (data) flow and does not exclude bidirectionality. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, while a port or an interface is present at an input/output connection point of an individual block in the relevant drawings, illustration of the port or the interface is omitted. In addition, in the following description, “A and/or B” signifies A or B or A and B.

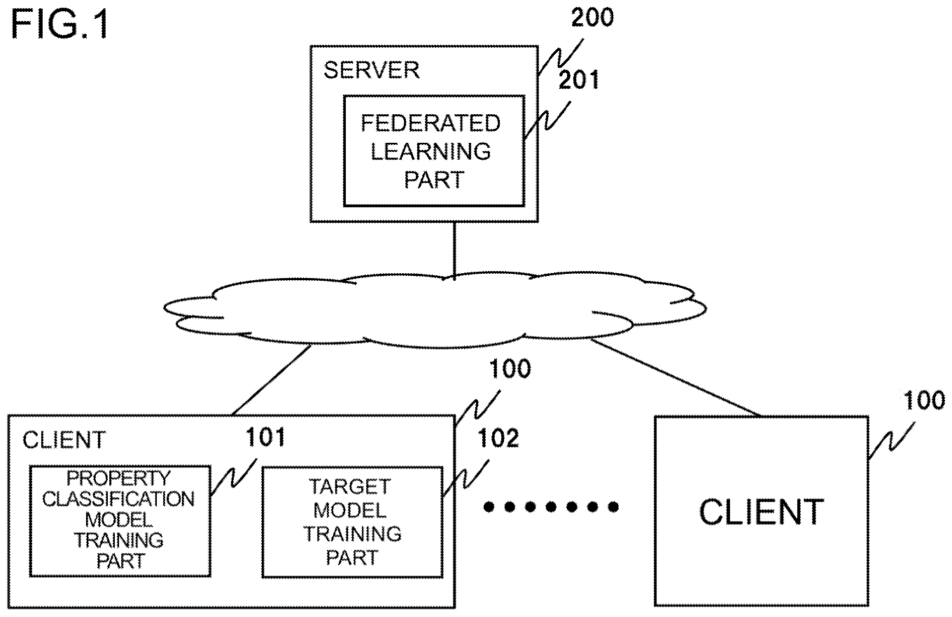

An example embodiment of the present invention can be realized by a machine learning system including one or more client(s) 100 and a server 200, as illustrated in FIG. 1. More concretely, the server 200 is provided with a federated learning part 201 which exchanges a model update parameter with the client(s) 100 by a federated learning (or collaborative learning) to train a target model.

The client(s) 100 is provided with a property classification model training part 101 and a target model training part 102. The property classification model training part 101 trains a classification model that infers a property of an input data from a gradient information (i.e., a classification model that is used upon inferring a property of an input data from a gradient information).

The target model training part 102 computes the gradient information of the target model using a training data, the target model and the classification model trained by the property classification model training part 101, and transmits the gradient information to the server. The property of the input data that the classification model infers can be set for each client., and the property classification model training part 101 trains the classification model using the target model and a second training data labelled with a teacher label regarding the property of the input data.

With above configuration, the gradient information for the federated learning can be computed using the classification model that infers the property of the input data from the gradient information in addition to the training data and the target model. Then, the classification model is trained using the property of the input data, which can be set for each client. This can make it difficult to infer the property of the input data from the gradient information computed by the relevant client.

### First Example Embodiment

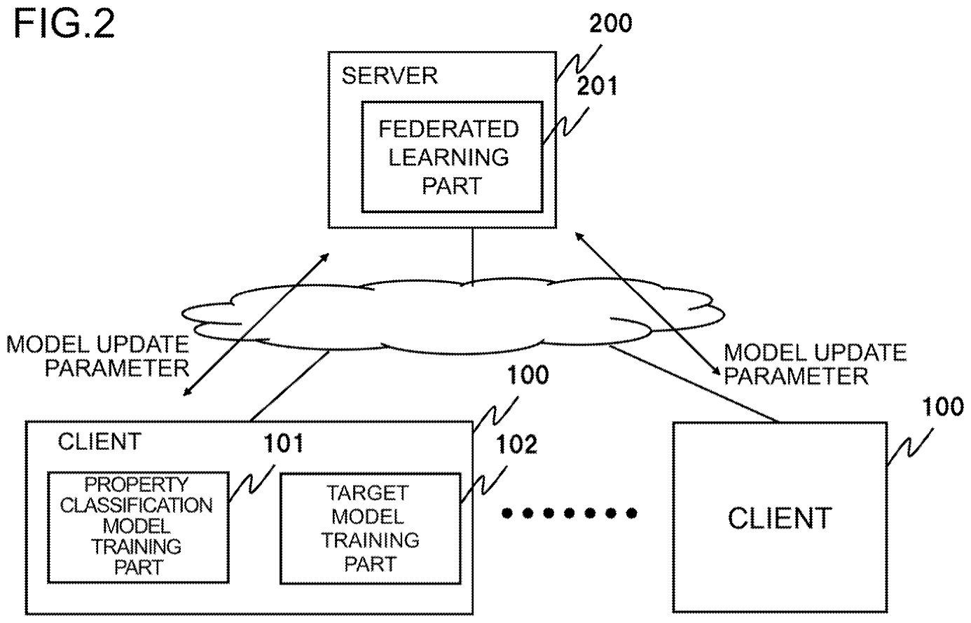

Subsequently, a first example embodiment of the present invention will be described in detail with reference to drawings. FIG. 2 is a block diagram illustrating a configuration of a machine learning system according to the first example embodiment of the present invention. Referring to FIG. 2, a configuration in which a plurality of clients 100 and a server 200 are connected via a network is shown.

The server 200 is provided with a federated learning part 201 that updates a target model based on a gradient information received from the clients 100 and distributes an update parameter of the updated target model to the clients 100. Hereinafter, the gradient information and the update parameter of the target model collectively referred to as “model update parameter”.

The clients 100 are each provided with a property classification model training part 101 and a target model training part 102. The target model training part 102 updates the target model upon receiving an update parameter for the target model from the server 200. The target model training part 102 computes a gradient information to be the update parameter for the target model using the updated target model and the training data occurred on the clients 100 sides. Furthermore, the target model training part 102 of the present embodiment computes the gradient information that makes inferring thereof difficult by using the classification model to infer the property of the input data from the gradient information as a regularization term, when computing the gradient information.

The property classification model training part 101 trains the classification model to infer the property of the input data from the gradient information, using the second training data prepared beforehand to improve its classification accuracy.

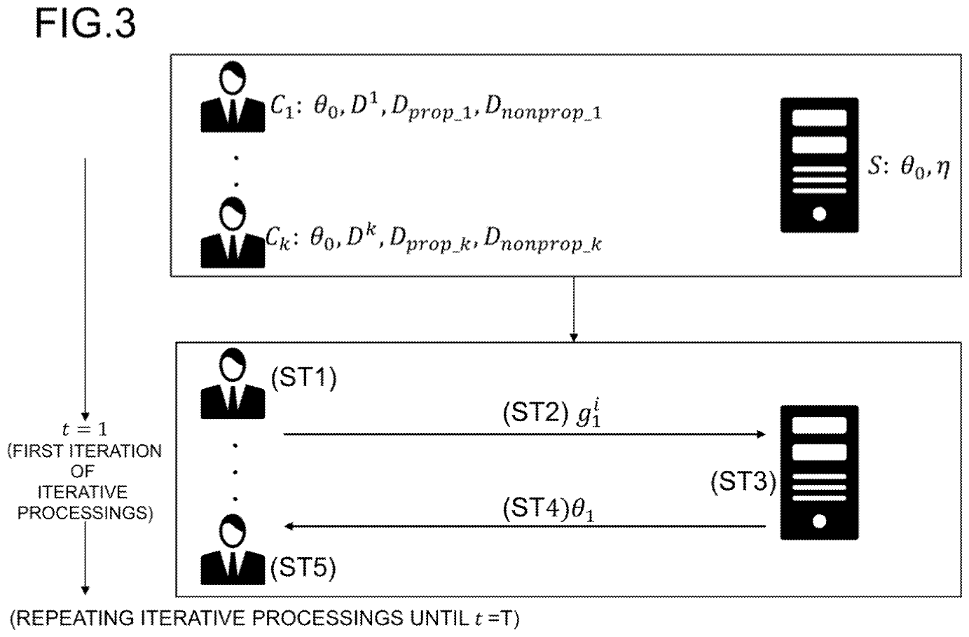

Subsequently, a whole operation of the federated learning of the machine learning system according to the first example embodiment will be described. FIG. 3 is a diagram for describing the whole operation of the machine learning system according to the first example embodiment of the present invention. Hereinafter, the example that k clients C₁˜Cₖ perform the federated learning with a server S will be described. Hereinafter, it is assumed that a parameter of the target model is updated sequentially from θ₀ in an initial state to θ_{T} which is an upper limit value of the batch size. The training data of an i-th client is denoted as Dⁱ. Furthermore, the training data Dⁱ is divided into a training data D_{prop_i}, in which the property (attribute) that the i-th client desires to protect satisfies a certain state, and the other training data D_{nonprop_i} and is prepared as a second training data. The property (attribute) that the i-th client desires to protect can be a variety of properties. For example, if training data Dⁱ is face image data and a target model is to infer its gender, this “property desired to protect” could be eye color, skin color, age (generation), etc. as expressed in the face image data. It is also clear from these examples that the value of the “property to be protected” need not be binary, but may be multivalued depending on the “property to be protected”.

Also, on the server S side, θ⁰ of the target model, and a hyper parameter η that represents a weighting at the federated learning are set in an initial state, as shown in FIG. 3.

In the above configuration, each of the clients Cᵢ and the server S operate as follows.

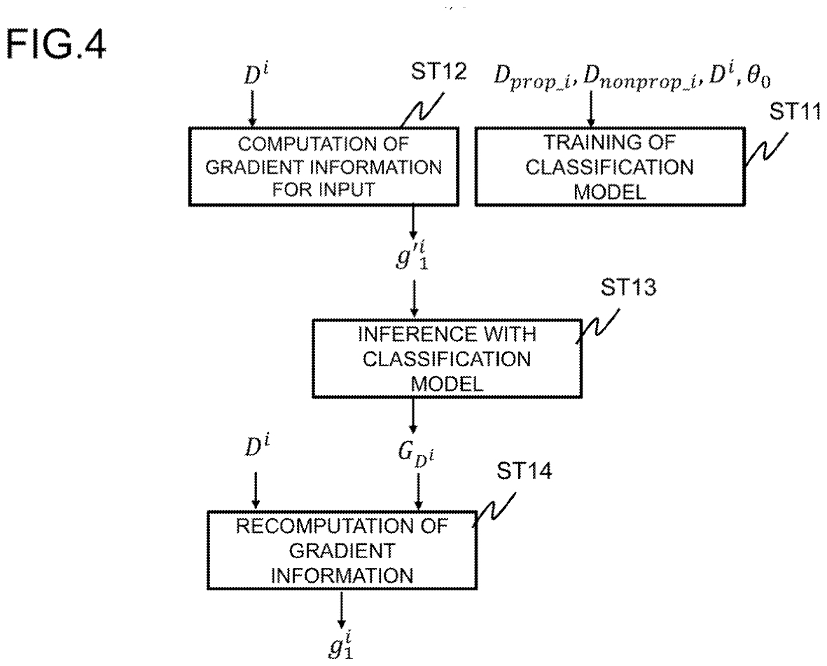

(ST1) The client Cᵢ computes a gradient information g₁ⁱ′ using the target model with parameter θ₀ set, the training data Dⁱ, the second training data D_{prop_i}, and the second training data D_{nonprop_i}. When computing this gradient information g₁ⁱ, each client Cᵢ trains its own classification model using the second training data D_{prop_i}, and the second training data D_{nonprop_i}, and then, each client Cᵢ computes the gradient information g₁ⁱ using the trained classification model in addition to the target model. The details are described later using FIG. 4.
(ST2) Each client Cᵢ transmits the gradient information g₁ⁱ computed in ST1 to the server S.
(ST3) The server S computes an updated parameter θ₁ of the target model using the gradient information g₁ⁱ received from each client Cᵢ, the target model with the parameter θ₀ set, and the hyper parameter η. The parameter θ₁ can be computed, for example, by a following expression (1).

θ₁=θ₀−ηΣᵢ₋₁^{k}g₁ⁱ (1)

(ST4) The server S transmits the updated parameter θ₁ of the target model to each client Cᵢ.
(ST5) Each client Cᵢ stores the updated parameter θ₁ of the target model received from the server S. Hereinafter, each client Cᵢ computes the gradient information using the updated parameter θ₁.

By iterating the above processings for T times, which is a predetermined batch size, the learning of the parameter of the target model is completed. It is noted that in the example shown in FIG. 3, the server S computed the parameter θ₁ at ST3. However, the server S may compute the update amount θ₁-θ₀ at ST3. In this case, the server S may transmit the update amount θ₁-θ₀ at ST4 and each client Cᵢ may add the θ₁-θ₀ to the θ₀ it holds.

FIG. 4 is a diagram for describing a procedure that the client(s) computes the gradient information at ST1 in FIG. 3 according to the first example embodiment of the present invention.

(ST11) Training of the Classification Model

Each client Cᵢ trains the classification model using the target model with parameter θ₀ set, the training data Dⁱ, the second training data D_{prop_i}, and the second training data D_{nonprop_i}. This training of the classification model can realize with an algorithm similar to a training algorithm for binary classifier disclosed as “Algorithm 3 Batch Property Classifier” in the Non-Patent Literature 1. It is noted that in the Algorithm 3 of the Non-Patent Literature 1, the binary Classifier fₚᵣₒₚ is trained after computing the gradient information gₚᵣₒₚ and gₙₒₙₚᵣₒₚ T times, however, the classification model can be trained every time the gradient information for training data D_{prop_i}, and training data D_{nonprop_i} is computed.

(ST12) Computation of a Gradient Information for Classification Model Input Using the Target Model.

Each client Cᵢ computes a gradient information for classification model input, independently of ST11 above. Concretely, each client Cᵢ computes the gradient information g′ⁱ₁ by performing training the target model with the parameter θ₀ set through inputting the training data Dⁱ thereto.

(ST13) Inference with a Classification Model

Each client C₁ obtains inference result G_{Di} by inputting the gradient information g′ⁱ₁ computed at ST12 into the classification model that is trained at ST11.

### (ST14) Recomputation of Gradient Information

Each client Cᵢ computes the gradient information gⁱ₁ using the inference result G_{Di} as the regularization term, in addition to the training data Dⁱ and the target model with the parameter θ₀ set. This gradient information gⁱ₁ can be computed, for example, by a following expression (2), where a loss function of a target model f is L_{θ0}, the inference result is G_{Di}, and a hyper parameter is 2.

$${min}_{f} ( {L}_{{θ}_{0}} + λ {G}_{{D}^{i}} ) \qquad ( 2 )$$

Finally, each client Cᵢ transmits the computed gradient information g to the server S (see (ST2) in FIG. 3).

It is noted that the classification model can be a multivalued classification model, i.e., n-class classification model. In that case, the regularization term G_{Di} in the above expression (2) is expressed by the following expression (3). Here, f_{θ} represents a target model with parameter θ, Dᵢ represents a dataset regarding a property (class)i, and hᵢ represents a score of the class i in the classification model.

$${G}_{{f}_{θ} , \{ {D}_{1} , … , {D}_{n} \}} = \frac{1}{n \vert {D}_{1} \vert} {\sum }_{( x , y ) ∈ {D}_{1}} {log}_{2} {h}_{1} ( x , y , ∇ {L}_{f} ( x , y , θ ) ) + … + \frac{1}{n \vert {D}_{n} \vert} {\sum }_{( x , y ) ∈ {D}_{n}} {log}_{2} {h}_{n} ( x , y , ∇ {L}_{f} ( x , y , θ ) ) \qquad ( 3 )$$

According to a method of the present example embodiment as described above, each client Cᵢ sets “the property desired to protect”, and can compute the gradient information g′i that minimizes a cost, using a different classification model, by taking into account an output of that classification model. It is therefore possible to improve the resistance against the attack that uses the gradient information of each client as input, according to the method of the present example embodiment. For example, a client A can compute a gradient information that makes it difficult to infer a skin color of an image of a person used for training, according to the method of the present example embodiment. Also, a client B, who performs a federated learning with the same server as the client A, can compute a gradient information that makes it difficult to infer the age (generation) of a person used for training, according to the method of the present example embodiment. As described above, it is possible to improve resistance to an attack method that attempts to infer the property of training data from a gradient information, without impairing the advantages of the federated learning, such as contributing to privacy protection, according to the present example embodiment.

### Second Example Embodiment

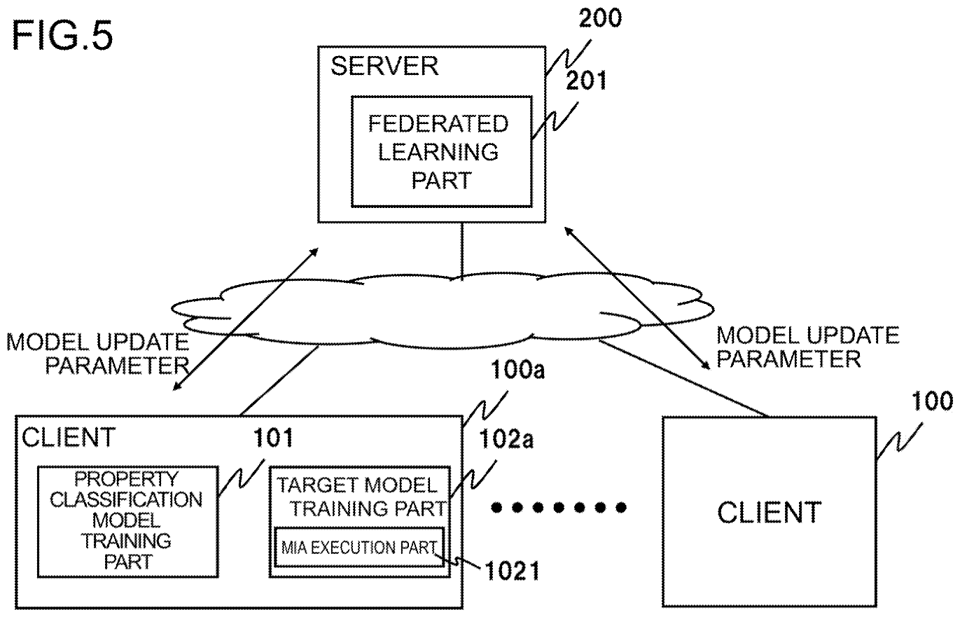

In the first example embodiment, example using an output from the classification model for a gain term is described, however, the present invention can be implemented with various modifications. For example, the method of computing a gradient information using an adversarial neural network proposed in the Non-Patent Literature 2 can be employed. This can be achieved by adding a MIA execution part 1021, which executes MIA (Membership Inference Attack) on an output of a target model, to the configuration shown in the first example embodiment (see FIG. 5). Then, a target model training part 102a of the present example embodiment trains the target model using an output of the MIA execution part 1021. Concretely, while the target model training part 102a trains a classifier in the MIA execution part 1021 to maximize an output of the classifier, it can compute the gradient information by training the target model using the output of the classifier after training as the regularization term.

### Third Example Embodiment

A configuration in which a gradient information is computed by using an influence function defined by the following expression (4), where a parameter of the target model is θ, and a parameter when a training data x is not used for training the target model is θ₋ₓ.

l_{f}(x,x)=θ₋ₓ−θ (4)

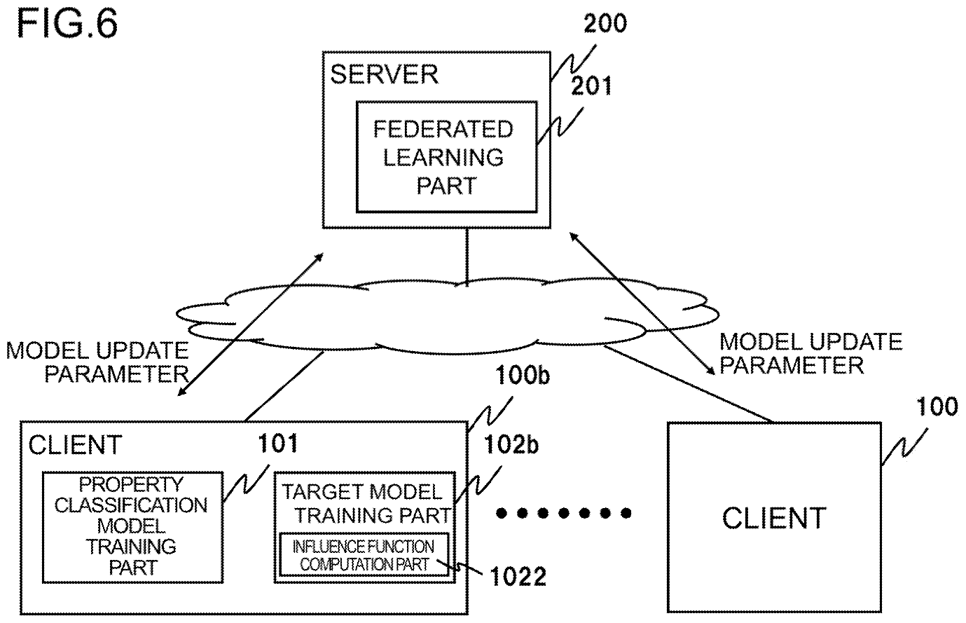

Concretely, an influence function computation part 1022 that computes the influence function described above, is added to the configuration shown in the first example embodiment (see FIG. 6). Then, a target model training part 102b of the present example embodiment computes the gradient information by training the target model using this influence function as the regularization term.

This training algorithm for the target model can be expressed by a following expression (5). Here, L_{Di}(f) represents a loss function of the target model f with a training data Dᵢ as input, and λ represents a hyper-parameter. In the following expression (5), an absolute value of influence function I_{f}(xᵢ, xᵢ) of the training data xᵢ is used as the regularization term.

min/f(L_{Di}(f)+|λl_{f}(xᵢ,xᵢ)|) (5)

The gradient information computed by the above expression (5) makes it difficult to identify the “property desired to protect”. The reason for this is that the influence function described above allows the target model f to be trained toward such a direction that both the variability of inference results depending on whether or not a certain data is used for training and the error in the inference results themselves are minimized.

While example embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the data illustrated in the drawings have been used only as examples to facilitate understanding of the present invention. That is, the present invention is not limited to the configurations illustrated in the drawings.

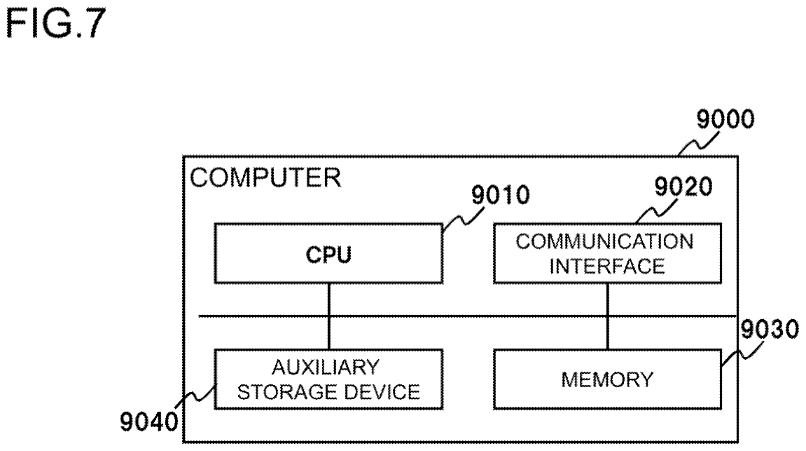

Each of the procedures described in the above example embodiments can be realized by a program that causes a computer (9000 in FIG. 7) which functions as a client to realize the function as the corresponding apparatus. This computer includes, for example, a CPU (Central Processing Unit) 9010, a communication interface 9020, a memory 9030, and an auxiliary storage device 9040 in FIG. 7. That is, the CPU 9010 in FIG. 7 performs a classification model training program and a target model training program and performs processing for updating various calculation parameters stored in the auxiliary storage device 9040, etc.

The disclosure of each of the above Patent Literatures and Non-Patent Literatures is incorporated herein by reference thereto and may be used as the basis or a part of the present invention, as needed. Modifications and adjustments of the example embodiments and examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

The present disclosure may be expressed as following modes, but not restricted thereto.

### [Mode 1]

The client as set forth as the first aspect.

### [Mode 2]

The client preferably according to Mode 1, wherein the target model training part computes the gradient information using a loss function corresponding to the target model and a regularization term using a gain obtained by inputting the gradient information into the classification model.
[Mode 3] The client preferably according to Mode 1 or 2, wherein the target model training part
comprises a classifier, the classifier judging whether or not data corresponding to the gradient information is data having a property that can be set for each client, based on an output of the classification model, trains the classifier to maximize an output of the classifier, and trains the target model using output of the classifier after training as the regularization term.

### [Mode 4]

The client preferably according to any one of Modes 1 to 3, further comprising:
an influence function computation part that computes an influence function, the influence function representing a sensitivity with which an input data affecting a parameter of the target model, wherein the target model training part trains the target model using the influence function as a regularization term.

### [Mode 5]

The client preferably according to Mode 4, wherein the influence function defines by a following expression (4), where a parameter of the target model is θ, and a parameter when a training data x is not used for training the target model is θ₋ₓ.

I_{f}(x,x)=θ₋ₓ−θ (4)

### [Mode 6]

The machine learning system as set forth as the second aspect.

### [Mode 7]

The machine learning method as set forth as the third aspect.

### [Mode 8]

The computer recording medium as set forth as the fourth aspect.

### REFERENCE SIGNS LIST

100, 100a, 100b client
101 property classification model training part
102, 102a, 102b target model training part
200 server
201 federated learning part
1021 MIA execution part
1022 influence function computation part
9000 computer
9010 CPU
9020 communication interface
9030 memory
9040 auxiliary storage device

What is claimed is:

1. A client connectable to a server, the server having a federated learning part, the federated learning part exchanging model update parameter including a gradient information with the client by a federated learning to train a target model comprising:
at least a processor and
a memory in circuit communication with the processor,
wherein the processor is configured to execute program instructions stored in the memory to implement:
a property classification model training part that trains a classification model, the classification model inferring a property of an input data from the gradient information; and
a target model training part that computes the gradient information of the target model using a training data, the target model and the classification model, and transmits the gradient information to the server,
wherein
the property of the input data that the classification model infers can be set for each client, and
the property classification model training part trains the classification model using the target model and a second training data labelled with a teacher label regarding the property of the input data.

2. The client according to claim 1, wherein
the target model training part computes the gradient information using a loss function corresponding to the target model and a regularization term using a gain obtained by inputting the gradient information into the classification model.

3. The client according to claim 1, wherein
the target model training part
comprises a classifier, the classifier judging whether or not data corresponding to the gradient information is data having a property that can be set for each client, based on an output of the classification model,
trains the classifier to maximize an output of the classifier, and
trains the target model using output of the classifier after training as the regularization term.

4. The client according to claim 1, further comprising:
an influence function computation part that computes an influence function, the influence function representing a sensitivity with which an input data affecting a parameter of the target model, wherein
the target model training part trains the target model using the influence function as a regularization term.

5. The client according to claim 4, wherein
the influence function defines by a following expression (4), where a parameter of the target model is θ, and a parameter when a training data x is not used for training the target model is θ₋ₓ.
I_{f}(x,x)=θ₋ₓ−θ (4)

6. A machine learning system comprising:
a server comprising:
at least a processor and a memory in circuit communication with the processor,
wherein the processor is configured to execute program instructions stored in the memory to implement:
a federated learning part that trains a target model by exchanging a model update parameter including gradient information with a client by a federated learning; and
a plurality of clients, wherein
each of the clients comprises:
at least a processor and
a memory in circuit communication with the processor,
wherein the processor is configured to execute program instructions stored in the memory to implement:
a property classification model training part that trains a classification model, the classification model inferring a property of an input data from the gradient information; and
a target model training part that computes the gradient information of the target model using a training data, the target model and the classification model, and transmits the gradient information to the server,
wherein
the property of the input data that the classification model infers can be set by each client, and
the property classification model training part trains the classification model using the target model and a second training data labelled with a teacher label regarding the property of the input data.

7. A machine learning method wherein
a client, connectable to a server, the server having a federated learning part, the federated learning part exchanging model update parameter including a gradient information with the client by a federated learning to train a target model,
trains a classification model, the classification model inferring a property of an input data from the gradient information; and
computes the gradient information of the target model using a training data, the target model and the classification model, and transmitting the gradient information to the server,
wherein
the property of the input data that the classification model infers can be set for each client, and
the property classification model training part trains the classification model using the target model and a second training data labelled with a teacher label regarding the property of the input data.

8. (canceled)

9. The client according to claim 2, wherein
the target model training part
comprises a classifier, the classifier judging whether or not data corresponding to the gradient information is data having a property that can be set for each client, based on an output of the classification model,
trains the classifier to maximize an output of the classifier, and
trains the target model using output of the classifier after training as the regularization term.

10. The client according to claim 2, further comprising:
an influence function computation part that computes an influence function, the influence function representing a sensitivity that an input data gives to a parameter of the target model, wherein
the target model training part trains the target model using the influence function as a regularization term.

11. The client according to claim 10, wherein
the influence function defines by a following expression (4), where a parameter of the target model is θ, and a parameter when a training data x is not used for training the target model is θ₋ₓ.
I_{f}(x,x)=θ₋ₓ−θ (4)

12. The machine learning system according to claim 6, wherein
the target model training part computes the gradient information using a loss function corresponding to the target model and a regularization term using a gain obtained by inputting the gradient information into the classification model.

13. The machine learning system according to claim 6, wherein
the target model training part
comprises a classifier, the classifier judging whether or not data corresponding to the gradient information is data having a property that can be set for each client, based on an output of the classification model,
trains the classifier to maximize an output of the classifier, and
trains the target model using output of the classifier after training as the regularization term.

14. The machine learning system according to claim 6, further comprising:
an influence function computation part that computes an influence function, the influence function representing a sensitivity with which an input data affecting a parameter of the target model, wherein
the target model training part trains the target model using the influence function as a regularization term.

15. The machine learning system according to claim 14, wherein
the influence function defines by a following expression (4), where a parameter of the target model is θ, and a parameter when a training data x is not used for training the target model is θ₋ₓ.
I_{f}(x,x)=θ₋ₓ−θ (4)

16. The machine learning method according to claim 7, wherein
the gradient information is computed using a loss function corresponding to the target model and a regularization term using a gain obtained by inputting the gradient information into the classification model.

17. The machine learning method according to claim 7, wherein
the client computes the gradient information by
training a classifier to maximize an output of the classifier, the classifier judging whether or not data corresponding to the gradient information is data having a property that can be set for each client, based on an output of the classification model, and
training the target model using an output of the classifier after training as the regularization term.

18. The machine learning method according to claim 7 wherein
the client computes the gradient information by training the target model using an influence function as a regularization term, the influence function representing a sensitivity that an input data gives to a parameter of the target model.

19. The machine learning method according to claim 18, wherein
the influence function defines by a following expression (4), where a parameter of the target model is θ, and a parameter when a training data x is not used for training the target model is θ₋ₓ.
I_{f}(x,x)=θ₋ₓ−θ (4)
